(19) United States
(12) Patent Application Publication
(10) Pub. No.: US 2015/0009119 A1
(43) Pub. Date: Jan. 8, 2015

(54) Built-in design of camera system for imaging and gesture processing applications

(71) Applicant: Imimtek, Inc., Palo Alto, CA (US)

(72) Inventors: Tony Zuccarino, Saratoga, CA (US); Abbas Rafii, Palo Alto, CA (US)

(73) Assignee: Imimtek, Inc., Palo Alto, CA (US)

(21) Appl. No.: 13/987,323

(22) Filed: Jan. 29, 2013

(51) Int. Cl. G06F 3/01

(52) U.S. Cl. CPC G06F 3/017
USPC 345/156

(57) ABSTRACT

Systems and method are disclosed for enabling a user to interact with gestures in a natural way with image(s) displayed on the surface of an integrated monitor whose display contents are governed by an appliance, perhaps a PC, smart phone or tablet. Some embodiments include the display as well as the appliance, in a single package such as all-in-one computers. User interaction includes gestures that may occur within a three-dimensional hover zone spaced apart from the display surface.

### FIELD OF INVENTION

The invention relates generally to design of a built-in systems for mobile devices enabling a user to interact with an electronic device and more specifically to enabling a user to interact in a natural manner using gestures and the like with a device in three-dimensions, using two-dimensional imaging implemented with ordinary low cost devices.

### BACKGROUND OF THE INVENTION

It is useful to enable a user to interact with the display of an electronic device by touching regions of the display, for example with a user's finger or a stylus. Existing so-called touch screens may be implemented with sensors and receptors arranged to provide a virtual (x,y) grid on the device display surface. Such mechanisms can sense where on the display user-contact was made. Newer touch screens may be implemented using more advanced capacitive or resistive sensing, or acoustic wave sensing to provide better touch resolution. Some prior art displays can sense multiple user touch points and implement user commands such as zoom, pan, rotate, etc. However these known systems require placing a sense layer over the typically LCD layer.

Understandably the cost of the resultant system will increase with increases in the display size, i.e., the LCD layer. Retrofitting touch sensing to an existing device LCD can be difficult, if not impossible.

In many systems it is desirable to allow the user to interact with a display, both in a three-dimensional hover region that is spaced-apart from the display surface (z>0) as well as on the (x,y) surface of the display screen. So-called time-of-flight (TOF) systems can implement such true three-dimensional sensing, and many U.S. patents for TOF systems have been awarded to Canesta, Inc., formerly of Sunnyvale, Calif. Such TOF systems emit active optical energy and determine distance (x,y,z) to a target by counting how long it takes for reflected-back emitted optical energy to be sensed, or by examining phase shift in the reflected-back emitted optical energy. The TOF sensor is an array of pixels, each of which produces a depth (z) signal and a brightness signal for the imaged scene. The pixel array density will be relatively low, in the QVGA or VGA class, yet the silicon size will be rather large because a typical TOF pixel is many times larger than a typical RGB camera pixel. TOF systems acquire true three-dimensional data and triangulation is not needed to detect an (x,y,z) location of an object on the surface of a display (x,y,0) or in a three-dimensional hover region (x,y,z z>0) spaced-apart from the display surface.

Although they can provide true three-dimensional (x,y,z) data, TOF systems can be relatively expensive to implement and can require substantial operating power. Environmental factors such as high ambient light, system temperature, pixel blooming, electronic noise, and signal saturation can all affect the accuracy of the acquired (x,y,z) data. Operational overhead associated with acquiring three-dimensional data can be high for a touchscreen hovering application. Identifying a user's finger in an (x,y,z) hover zone for purposes of recognizing a gesture need only require identifying perhaps ten points on the finger. But a TOF system cannot simply provide three-dimensional data for ten points but must instead image the entire user's hand. If in the TOF system the pixel array comprises say 10,000 pixels, then the cost of acquiring 10,000 three-dimensional data points must be borne, even though only perhaps ten data points (0.1% of the acquired data) need be used to identify (x,y,z), and (x,y,0) information.

So-called structured-light systems are an alternative to TOF systems. Structured-light systems can be employed to obtain a three-dimensional cloud of data for use in detecting a user's hovering interactions with a display screen. A structured light system projects a stored, known, calibrated light pattern of spots on the target, e.g., the display surface. As the user's hand or object approaches the display surface some of the projected spots will fall on and be distorted by the non-planar hand or object. Software algorithms can compare the internally stored known calibrated light pattern of spots with the sensed pattern of spots on the user's hand to calculate an offset. The comparison can produce a three-dimensional cloud of the hover zone that is spaced-apart from the display surface. A group of pixels is used to produce a single depth pixel, which results in low x-y resolution. Unfortunately structured light solutions require special components and an active light source, and can be expensive to produce and require substantial operating power. Furthermore, these systems require a large form factor, and exhibit high latency, poor far depth resolution, and unreliable acquired close distance depth data as a function of pattern projector and lens architecture. Other system shortcomings include pattern washout under strong ambient light, a need for temperature management, difficulty with sloped object surfaces, severe shadowing, and low field of view.

Common to many prior art hover detection systems is the need to determine and calculate (x,y,z) locations for thousands, or tens of thousands, or many hundreds of thousands of points. For example, a stereo-camera or TOF prior art system using a VGA-class sensor would acquire (640.480) or 307,200 (x,y) pixel locations from which such systems might produce perhaps 80,000 to 300,000 (x,y,z) location points. If a high definition (HD-class) sensor were used, there would be (1280.720) or 921,600 (x,y) pixel locations to cope with. Further, stereoscopic cameras produce a poor quality three-dimensional data cloud, particularly in regions of the scene where there is no texture, or a repetitive pattern, e.g., a user wearing a striped shirt. The resultant three-dimensional data cloud will have missing data, which makes it increasingly difficult for detection software to find objects of interest. As noted above, the overhead cost of producing three-dimensional data for every pixel in the acquired images is immense. The computational overhead and data throughput requirements associated with such large quantity of calculations can be quite substantial. Further special hardware including ASICs may be required to handle such massive computations.

Occlusion remains a problem with the various prior art systems used to implement natural user interface applications with single optical axis three-dimensional data acquisition cameras. Occlusion occurs when a part of the scene cannot be seen by the camera sensor. In TOF systems and in structured light systems, depth (x,y,z) calculations can only be performed on regions of the scene visible to both the actively emitted optical energy and to the camera sensor. Occluded objects can be less troublesome for systems that employ multiple cameras as the scene is simultaneously viewed from multiple different vantage points. In general, traditional multi-camera systems including those employing a base line also have problems producing a three-dimensional cloud of data efficiently, especially when the imaged scene includes repeated patterns, is texture-free, or has surface reflections.

What is needed is a method and system to sense user interaction in a three-dimensional hover zone away from the surface of the display on a monitor, that may complement an existing touch sensitive solution, or replace it altogether. The system preferably should meet industry accuracy and resolution standards without incurring the cost, large form factor, and power consumption associated with current commercial devices that acquire three-dimensional data. Such method and system should function without specialized components, and should acquire data from at least two vantage points using inexpensive ordinary imaging cameras without incurring the performance cost and limitations, and failure modes of current commercial multi-view optical systems. Computationally, such system should expend resource to determine and reconstruct (x,y,z) data points only for those relatively few landmark points relevant to the application at hand, without incurring the overhead and cost to produce a three-dimensional cloud. Preferably such system should be compatible with existing imaging applications such as digital photography, video capture, and three-dimension capture. Preferably such system should be useable with display sizes ranging from cell phone display to tablet display to large TV displays. Preferably such system should provide gesture recognition in a hover zone that can be quite close to a display screen surface, or may be many feet away. Preferably such system should have the option to be retrofittably installed in an existing display system.

The present invention provides the built-in industrial design of such systems and methods for implementing such systems.

### SUMMARY OF THE PRESENT INVENTION

The present invention enables a user to interact with gestures in a natural way with image(s) displayed on the surface of an integrated monitor whose display contents are governed by an appliance, perhaps a PC, smart phone or tablet. In some embodiments, the present invention includes the display as well as the appliance, in a single package such as All-in-one computers. User interaction is not confined to touching the physical surface of the display but includes gestures that may occur within a three-dimensional hover zone spaced apart from the display surface. Advantageously the present invention enables a cross-section of the three-dimensional hover zone parallel to a plane of the display to be greater than the transverse dimension of the display. This permits enabling user interaction with an appliance whose display size may be small, e.g., a few cm diagonally, or large, e.g., an entertainment room TV. Indeed low cost, low form factor, and low power consumption enable fabricating embodiments of the present invention into small hand-held devices such as smart phones, whose small screens serve as the display screen.

The present invention includes at least two generic off-the-shelf two-dimensional cameras that preferably are pre-calibrated, and an electronic system including a processor and software coupled to the cameras. The system is coupled to a display and to an appliance, which appliance can in fact provide the processor and software. In some embodiments, the present invention provides the cameras, electronic system, device and display as a single unit.

The two cameras are functionally coupled in a grid, to substantially simultaneously capture from their respective vantage points two-dimensional images of the user or user object within a three-dimensional hover zone. Camera image information can be signal processed individually and collectively. The camera sensors detect RGB, monochrome, or even IR spectral energy, but need not be identical in terms of resolution and fields of view, or even spectral sensitivity. The hover zone is the three-dimensional space defined by the intersection of the three-dimensional fields of view (FOVs) of the cameras. Preferably the cameras are disposed at a small vergence angle relative to each other to define a desirable hover zone, preferably to provide maximum volume hover zone coverage at a given distance to the monitor display surface. Preferably the cameras are calibrated and modeled to have characteristics of pinhole cameras. So doing enables application of epipolar geometric analysis to facilitate more rapid disambiguation among potential landmark points during three-dimensional reconstruction.

Aggregated frames of two dimensional information acquired by the cameras of the user or user object (e.g. finger tips, fingers, hands, head, etc.) in the hover zone are communicated at a frame rate for processing by an electronic system. This two-dimensional information is signal processed by an electronic system to identify potential landmark points representing the imaged object(s). In essence the imaged user or user object is representation by a relatively small number of landmark points, certainly fewer than about one hundred potential landmarks, and perhaps only a dozen or so landmarks. Signal processing then yields three-dimensional (x,y,z) data for these landmark points defined on the imagery acquired from the user, to the exclusion of having to determine three-dimensional locations for non-relevant-landmark points. In this fashion the present invention can operate rapidly using inexpensive components to yield three-dimensional reconstruction of relevant landmark points. Gesture recognition may be fed back to the appliance to alter the displayed imagery accordingly. In most applications the cameras acquire such data using ambient light, although the present invention can include an active light source, whose spectral content in suitable for the camera sensors, for use in dimly illuminated environments.

Calculating (x,y,z) locations for a relatively few landmark points, fewer than about one hundred potential landmarks and perhaps as few as a dozen or so landmark points, according to the present invention is clearly more readily carried out than having to calculate perhaps 120,000 (x,y,z) locations according to the prior art. Indeed, calculating 12 or so (x,y,z) locations versus 120,000 (x,y,z) locations per the prior art is a savings of about 99.99% in favor of the present invention. The electronic system includes software and at least one algorithm that recognizes user gesture(s) from the (x,y,z) data created from the two-dimensional camera image data.

The perhaps one hundred potential landmarks, or more typically the dozen or so exemplary landmark points defined by the present invention can be the fingertips, centroids of the user's hand(s), approximate centroid of the user's head, elbow joint locations, shoulder joint locations, etc. From the invention's standpoint the user is definable as a figure having a relatively small number of landmark points. Thus, the cameras' two-dimensional image data is signal processed to create very sparse three-dimensional information, e.g., perhaps 0.01% or so of the potential number of (x,y,z) points on the user or user object, generally well under 1% of the potential number of (x,y,z) points. As such, the three-dimensional information need only be the relatively minimal (x,y,z) positional information for those landmark points needed to identify a stick-figure outline of the user (or user object), and to recognize any user gesture(s) made within the three-dimensional hover zone. In the present invention, the use of a minimal number of (x,y,z) landmark points, generally potentially one hundred or less, and typically perhaps a dozen or so landmarks, is sufficient information needed by a companion software routine or application to implement higher level functions such as user body pose tracking and gesture interpretation.

The electronic system includes a processor unit that acquires the two-dimensional data from each camera, signal processes the acquired two-dimensional images to recognize therein and reconstruct a relatively few landmark points (x,y,z) within the three-dimensional hover zone as will suffice to identify user gesture(s). Advantageously the use of at least two conventional cameras to substantially simultaneously image the user or user object(s) from their respective vantage points enables signal processing to create the relatively small set of three-dimensional (x,y,z) landmark data points. These landmark points are essentially created on demand as needed, for example fingertip landmark points for a hand, head landmark points for a head, etc. The processor unit communicates with the application driving the imagery presented on the display screen, and enables the user to interact in a natural manner with such imagery. For example, a user might play a virtual game of tennis against an image of a tennis player on the screen serving a tennis ball to the user.

An algorithm within the processor unit extracts objects of interest, e.g., hands, fingers, user head orientation, in each image acquired by the cameras, to interpret the user's intent in make a gesture. Landmarks, previously defined by the software, are identified in the objects, e.g., fingertips, finger axis, user pose. This landmark information from the various cameras is combined to locate the landmarks on the user in real world coordinates (x_{w}, y_{w}, z_{w}) The processor unit interprets three-dimensional information including motion, location, connection and inter-relationship properties of the landmarks to create events, e.g., move the displayed image in a certain fashion. The created events are coupled to at least one companion system, being the device that the cameras are built-in (or attached) such as digital computer, laptop PC, tablet, smart phone, TV, etc. Optionally shapes and location properties of at least some landmarks can be interpreted and coupled to drive immersion applications in social networks, and entertainment devices, with optional feedback provided to the . . . .

### DESCRIPTION AND EXPLANATION OF DRAWINGS

The built-in industrial design of the present invention for various electronic device types are described in FIGS. 9-1 to 9-12.

FIG. 1A is a front view of an embodiment of the present invention;

FIG. 1A-1 is a block diagram of an exemplary camera, according to embodiments of the present invention;

FIG. 1B is a side view of FIG. 1, according to embodiments of the present invention;

FIG. 1C is a top view of FIG. 1A, according to embodiments of the present invention;

FIG. 1D-1 is a front view of FIG. 1A, with a variable camera displacement option, according to embodiments of the present invention;

FIG. 1D-2 is a front view similar to FIG. 1D-1 except cameras 80-1, 80-2 are disposed away from the monitor, according to embodiments of the present invention;

FIG. 1E is a front view of a handheld device, according to embodiments of the present invention;

FIG. 1F is a side view of FIG. 1E, according to embodiments of the present invention;

FIG. 1G is a top view of FIG. 1E, according to embodiments of the present invention;

FIG. 1H is a front view of FIG. 1E, with the handheld device rotated to operate in landscape mode, according to embodiments of the present invention;

FIG. 1I is a side view of FIG. 1H, according to embodiments of the present invention;

FIG. 1J is a top view of FIG. 1H, according to embodiments of the present invention;

FIGS. 2A-2C depict use of device gyroscope(s) and/or accelerometer(s) to change user interaction and device display, according to embodiments of the present invention;

FIG. 3 is a block diagram of a system, according to embodiments of the present invention;

FIG. 4A depicts the relationship between world coordinates and local coordinates, according to embodiments of the present invention;

FIGS. 4B-FIG. 4G depict use of epipolar-line camera system geometric properties to disambiguate multiple corresponding potential landmark candidates, according to embodiments of the present invention;

FIG. 5 is a flow chart depicting exemplary method steps in detecting a fingertip landmark, according to embodiments of the Ser. No. 13/385,134 application;

FIG. 6 is a flow chart depicting exemplary method steps for detecting a fingertip landmark using epipolar geometric analysis including image rectification, according to embodiments of the present invention;

FIG. 7A depicts the many process steps and associated high bandwidth data rate requirements associated with three dimensional sensing methods according to the prior art;

FIG. 7B depicts the relatively fewer process steps and associated low bandwidth data rates to acquire three-dimensional coordinates for a relatively few landmark points, according to embodiments of the present invention; and

FIGS. 8A-8K depict latency improvements provided by embodiments of the present invention.

FIG. 9-1a: A preferred exemplary embodiment of mechanical placement of at least two cameras disposed at the bottom bezel of a laptop-class computer for the purpose producing among other applications images For 3D positional information of landmarks such as user fingers, hands and face for 3D gesture processing purposes. the low cost ordinary sensors identified with double circles in the figure are preferably VGA or HD-class color or IR sensors placed at distances from 4 cm-10 cm from each other as measured from the optical center of each sensor. The dash block around the sensors is depiction of the hidden board that supports control and communication circuitry (as needed) and creates a substantially fixed foundation for the sensors. The sensors preferably having vertical and horizontal field of views between 40-70 degrees, and small vergence angle with respect to each other preferably from 0-6 degrees allowing an overlap of the FOV of both sensors that images the area above the keyboard and to a comfortable distance from the screen, preferably, from 20-150 cm.

FIG. 9-2 an exemplary embodiment of mechanical placement of at least two camera sensors disposed at the top bezel of a laptop-class computer for the purpose producing among other applications mages for 3D positional information of landmarks such as user fingers, hands and face for 3D gesture processing purposes. the low cost ordinary sensors identified with double circles in the figure are preferably VGA or HD-class color or IR sensors placed at distances from 4 cm-10 cm from each other as measured from the optical center of each sensor. the dash block around the sensors is depiction of the hidden board that supports control and communication circuitry (as needed) and creates a substantially fixed foundation for the sensors. the sensors preferably having vertical and horizontal field of views between 40-70 degrees, and small vergence angle with respect to each other preferably from 0-6 degrees allowing an overlap of the FOV of both sensors that images the area above the keyboard and to a comfortable distance from the screen, preferably, from 20-150 cm.

FIG. 9-3 a preferred exemplary embodiment of side-view mechanical placement of at least two camera sensors disposed at the bezel of an electronic device substantially behind the glass for the purpose among other applications producing images for 3D positional information of landmarks such as user fingers, hands and face for 3D gesture processing purposes. The low cost ordinary sensors, one of which identified with solid line, in the figure are preferably VGA or HD-class color or IR sensors placed at distances from 4 cm-10 cm from each other as measured from the optical center of each sensor. The sensors preferably having vertical and horizontal field of views between 40-70 degrees, and small (horizontal) vergence angle with respect to each other preferably from 0-6 degrees allowing an overlap of the FOV of both sensors that images the area above the keyboard and to a comfortable distance from the screen, preferably, from 20-150 cm.

FIG. 9-4 an exemplary embodiment of mechanical placement of at least two camera sensors disposed at the top bezel of a laptop-class computer for the purpose of among other applications producing images for 3D positional information of landmarks such as user fingers, hands and face for 3D gesture processing purposes. The low cost ordinary sensors identified with double circles in the center of top bezel is presumably an existing typical laptop sensor. The second low cost ordinary sensors identified with double circles next to the center sensor in the top bezel is an additional camera sensor of preferably but not necessarily equal resolution. The second sensor being another color, or perhaps and IR only sensor. the sensors placed at distances from 4 cm-10 cm from each other as measured from the optical center of each sensor. The dash block around the sensors is depiction of the hidden board that supports control and communication circuitry (as needed) and creates a substantially fixed foundation for the sensors. The sensors preferably having vertical and horizontal field of views between 40-70 degrees, and small vergence angle with respect to the center sensor preferably from 0-6 degrees allowing an overlap of the FOV of both sensors that images the area above the keyboard and to a comfortable distance from the screen, preferably, from 20-150 cm.

FIG. 9-5 a preferred exemplary embodiment of mechanical placement of at least two camera sensors disposed at the top bezel of a smart-phone class device for the purpose producing among other applications mages for 3D positional information of landmarks such as user fingers, hands and face for 3D gesture processing purposes. The low cost ordinary sensors identified with double circles in the figure are preferably VGA or HD-class color or IR sensors placed at distances from 4 cm-7 cm from each other as measured from the optical center of each sensor. The dash block around the sensors is depiction of the hidden board that supports control and communication circuitry (as needed) and creates a substantially fixed foundation for the sensors. the sensors preferably having vertical and horizontal field of views between 40-70 degrees, and small vergence angle with respect to each other preferably from 0-6 degrees allowing an overlap of the FOV of both sensors that images the area above the screen and to a comfortable distance from the screen, preferably, from 10-70 cm.

FIG. 9-6 an exemplary embodiment of mechanical placement of at least two camera sensors disposed at the top bezel of a smart-phone class device for the purpose producing among other applications mages for 3D positional information of landmarks such as user fingers, hands and face for 3D gesture processing purposes. The low cost ordinary sensor identified by double circles at the center is presumably an existing phone sensor preferably of VGA or HD-class color. the other sensor next to the center sensor (either on the left or right of the center sensor—left shown) is another low cost color or IR sensor preferably but not necessarily of the same resolution of the existing center sensor. The distance between the two sensors are preferably between 2 cm-3.5 cm from each other as measured from the optical center of respective sensor. The dash block around the sensors is depiction of perhaps the hidden board that supports control and communication circuitry (as needed) and creates a substantially fixed foundation for the sensors. The sensors preferably having vertical and horizontal field of views between 40-70 degrees, and small vergence angle with respect to each other preferably from 0-6 degrees allowing an overlap of the FOV of both sensors that images the area above the screen and to a comfortable distance from the screen, preferably, from 10-70 cm.

FIG. 9-7 a preferred exemplary embodiment of mechanical placement of at least two camera sensors disposed on the bezel of a smart-phone class device for the purpose producing among other applications mages for 3D positional information of landmarks such as user fingers, hands and face for 3D gesture processing purposes. The low cost ordinary sensors identified by double circles are preferably of VGA or HD-class color sensors. The distance between the two sensors are preferably between 4 cm-7 cm from each other as measured from the optical center of respective sensor. The dash block around the sensors is depiction of perhaps the hidden board that supports control and communication circuitry (as needed) and creates a substantially fixed foundation for the sensors. The sensors preferably having vertical and horizontal field of views between 40-70 degrees, and small vergence angle with respect to each other preferably from 0-6 degrees allowing an overlap of the FOV of both sensors that images the area above the screen and to a comfortable distance from the screen, preferably, from 10-70 cm.

FIG. 9-8 a preferred exemplary embodiment of mechanical placement of at least two camera sensors disposed on the bezel of a pad or tablet-pad-class device (in portrait or landscape orientation-as shown) for the purpose producing among other applications mages for 3D positional information of landmarks such as user fingers, hands and face for 3D gesture processing purposes. The low cost ordinary sensors identified by double circles are preferably of VGA or HD-class color sensors. The distance between the two sensors are preferably between 4 cm-10 cm from each other as measured from the optical center of respective sensor. The dash block around the sensors is depiction of perhaps the hidden board that supports control and communication circuitry (as needed) and creates a substantially fixed foundation for the sensors. The sensors preferably having vertical and horizontal field of views between 40-70 degrees, and small vergence angle with respect to each other preferably from 0-6 degrees allowing an overlap of the FOV of both sensors that images the area above the screen and to a comfortable distance from the screen, preferably, from 15-100 cm.

FIG. 9-9 a exemplary embodiment of mechanical placement of at least two camera sensors disposed on the bezel of a pad or tablet-pad-class device for the purpose producing among other applications mages for 3D positional information of landmarks such as user fingers, hands and face for 3D gesture processing purposes. The low cost ordinary sensors identified by dashed or solid double circles are preferably of VGA or HD-class color sensors. The direct distance between the two sensors are preferably between shall be governed by the size of tablet but preferably larger than 5cm from each other as measured from the optical center of respective sensor. The dash block around each sensor is depiction of perhaps the hidden board that supports control and communication circuitry (as needed) and creates a substantially fixed foundation for the sensors. The sensors preferably having vertical and horizontal field of views between 40-70 degrees, and small vergence angle with respect to each other preferably from 0-6 degrees allowing an overlap of the FOV of both sensors that images the area above the screen and to a comfortable distance from the screen, preferably, from 15-100 cm.

FIG. 9-10 the side view of the sensors preferably substantially aligned or under a glass (see also figures related to smart phone or tablet computers).

FIG. 9-11 a preferred embodiment for a monitor or an all-in-one computer (see also FIG. 9-1)

FIG. 9-12 a preferred embodiment for a monitor computer (see also FIG. 9-3)

FIG. 9-13 a preferred embodiment for an all-in-one computer (see also FIG. 9-1)

FIG. 9-14 a preferred embodiment for an all-in-one computer (see also FIG. 9-3)

FIGS. 9-15a,b,c,d: The advantage of the preferred embodiment of mechanical placement of the cameras disposed at the bottom bezel over placing in on the top are shown.

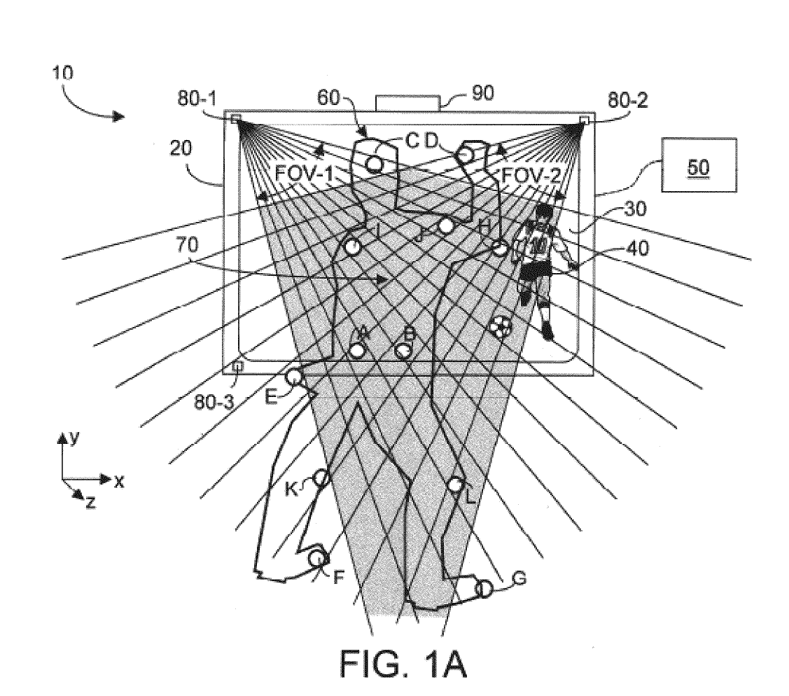

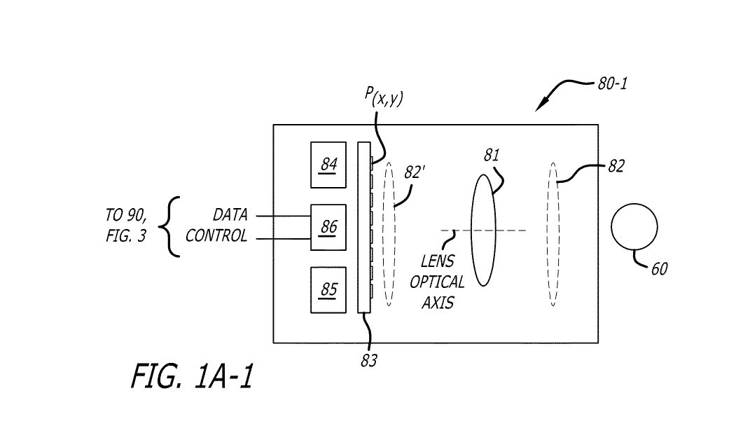

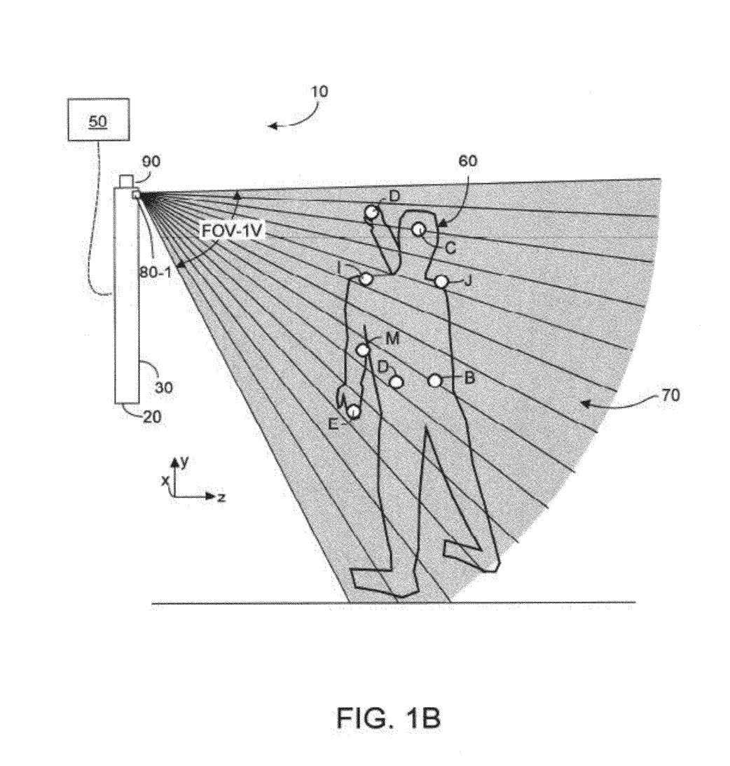

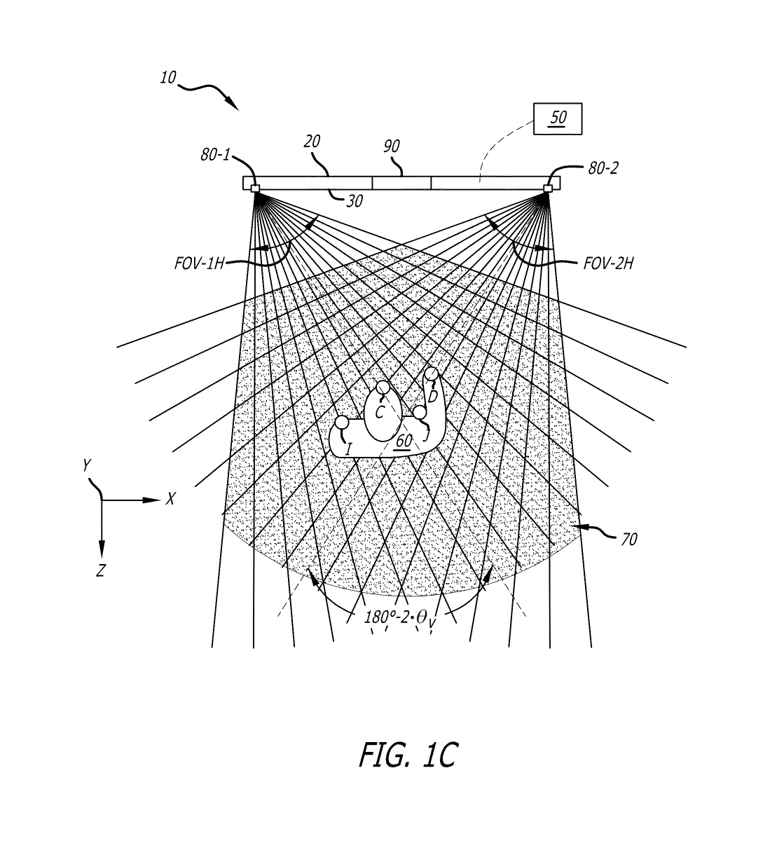

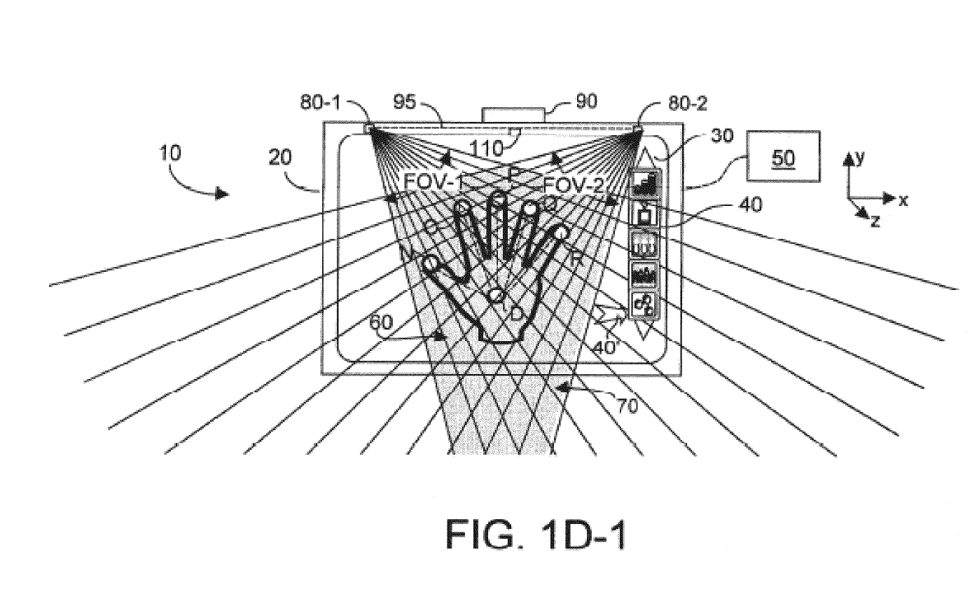

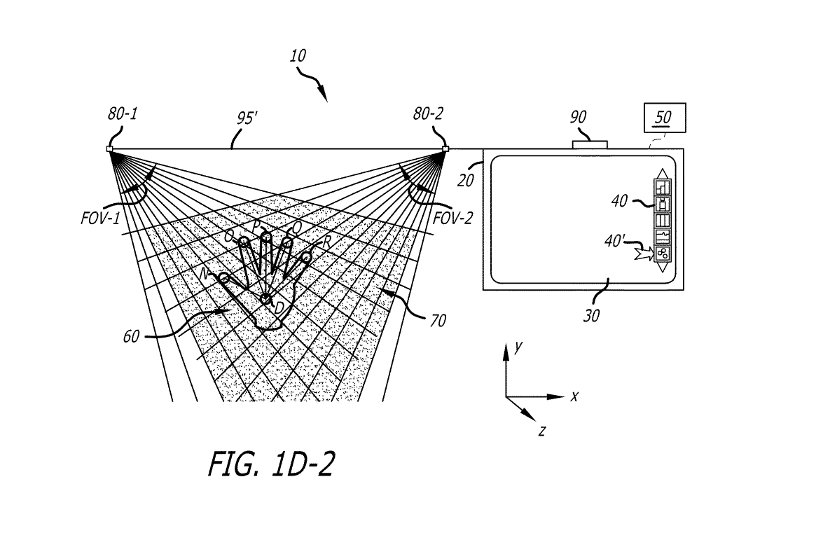

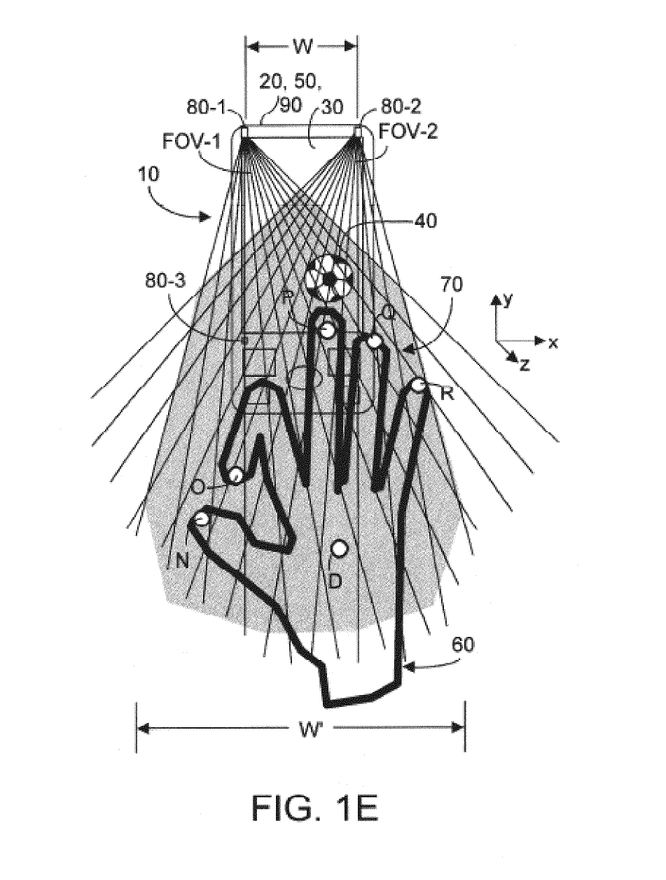

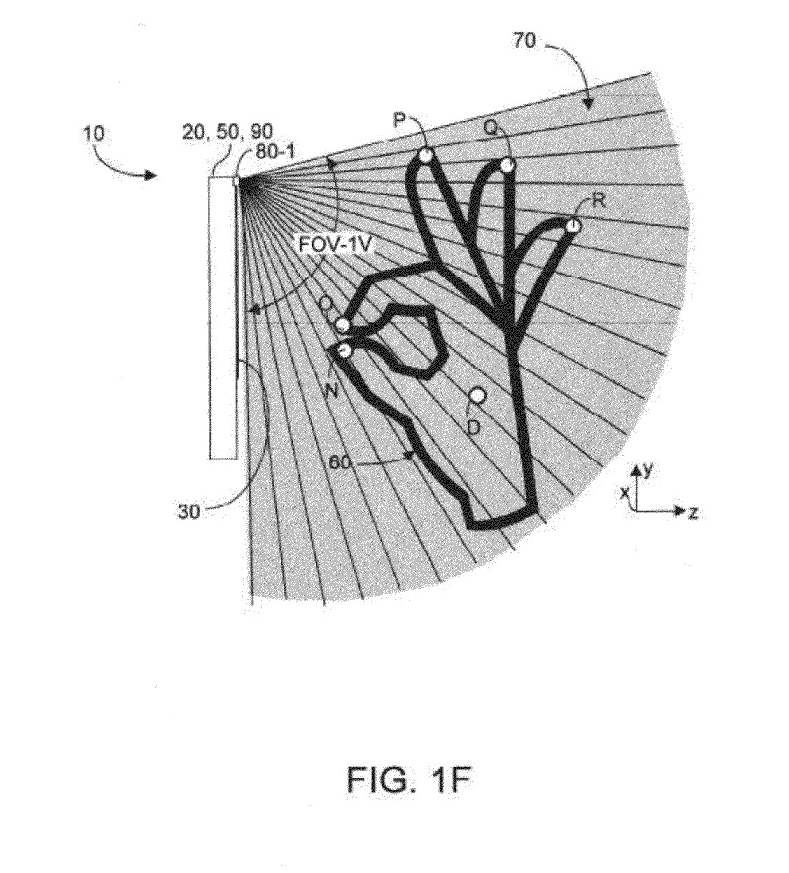

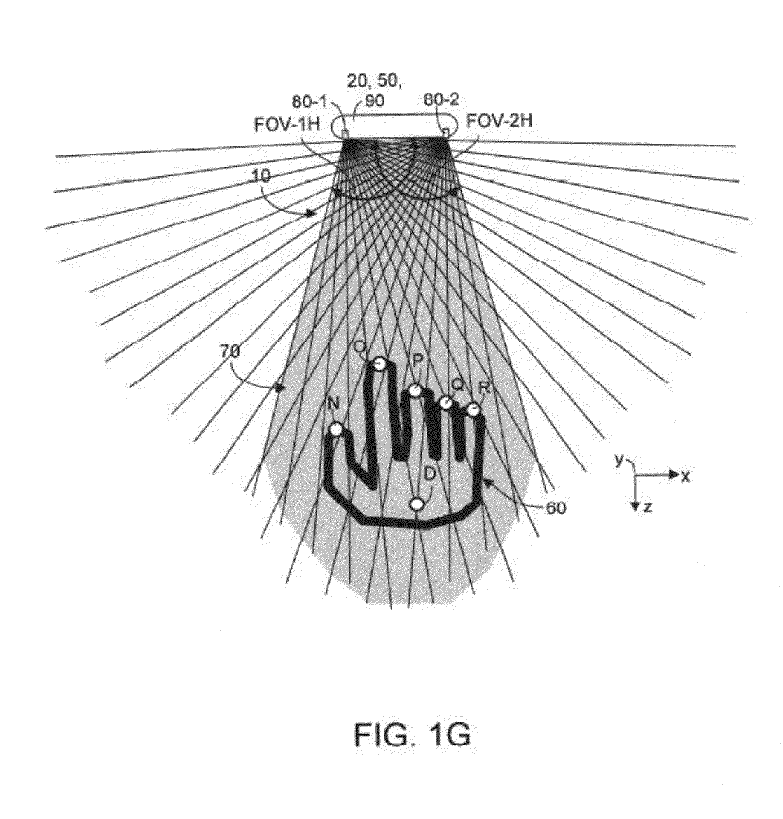

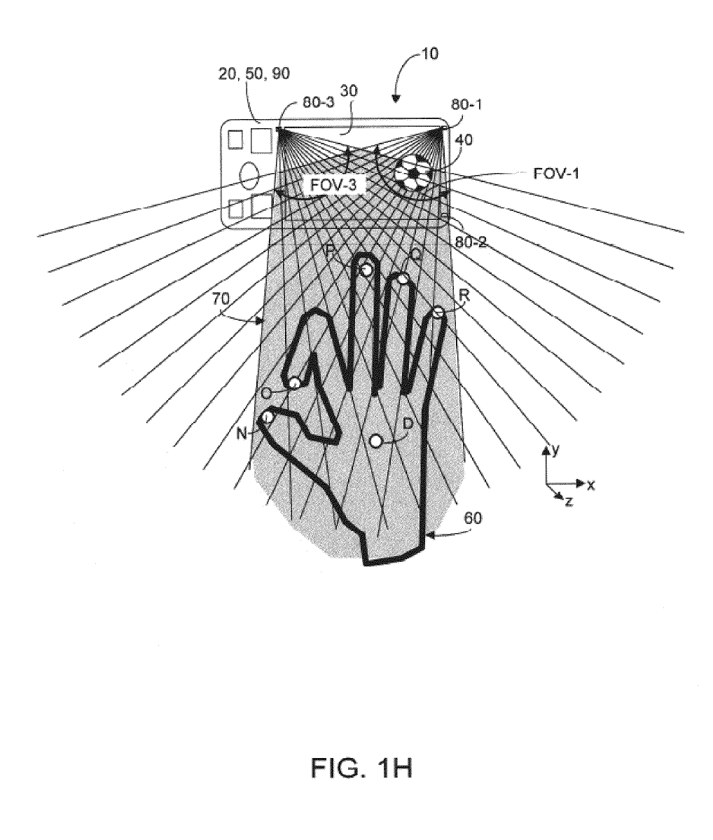

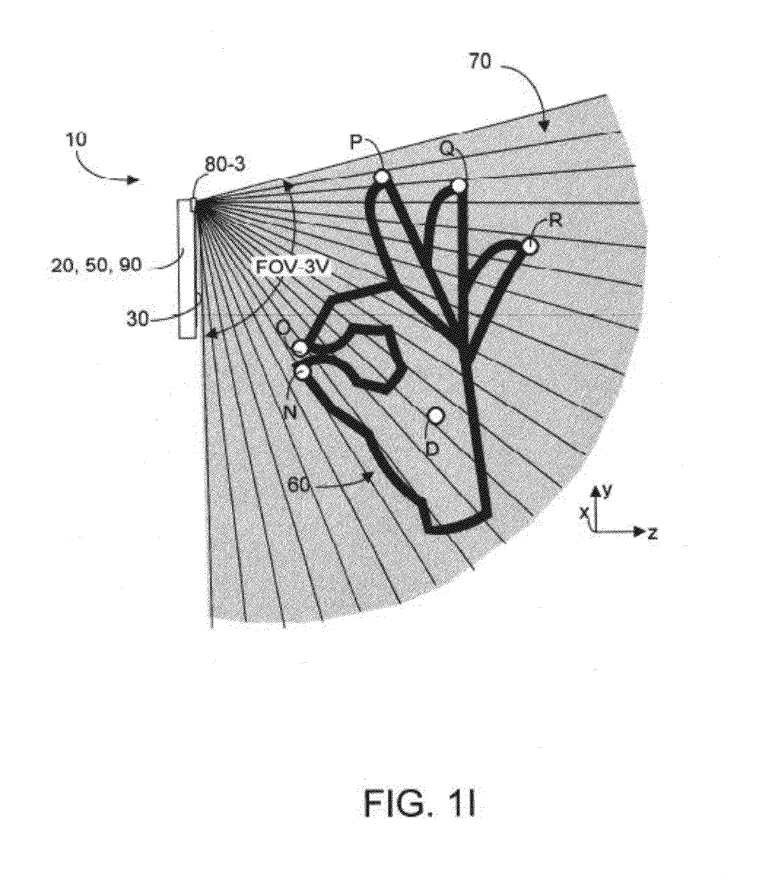

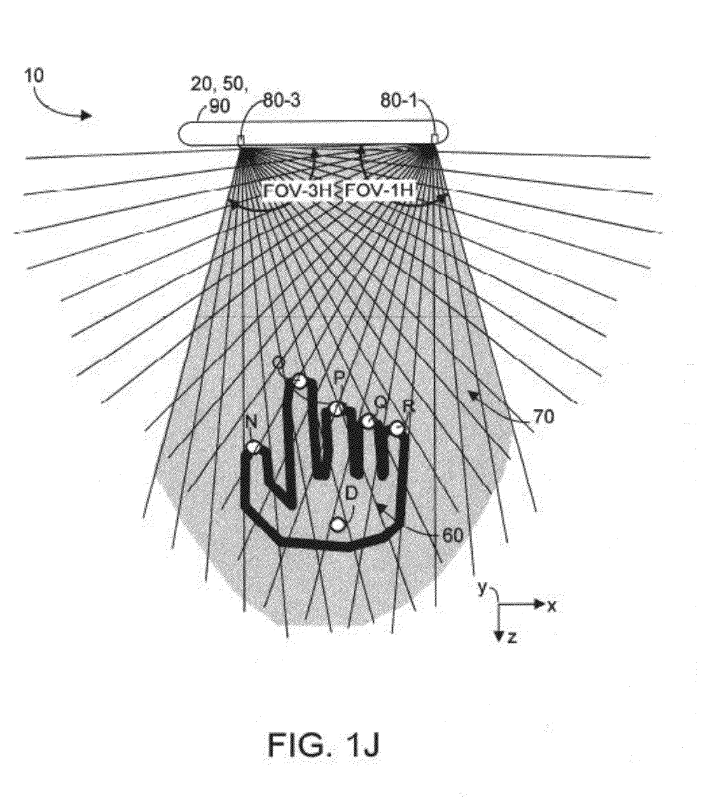

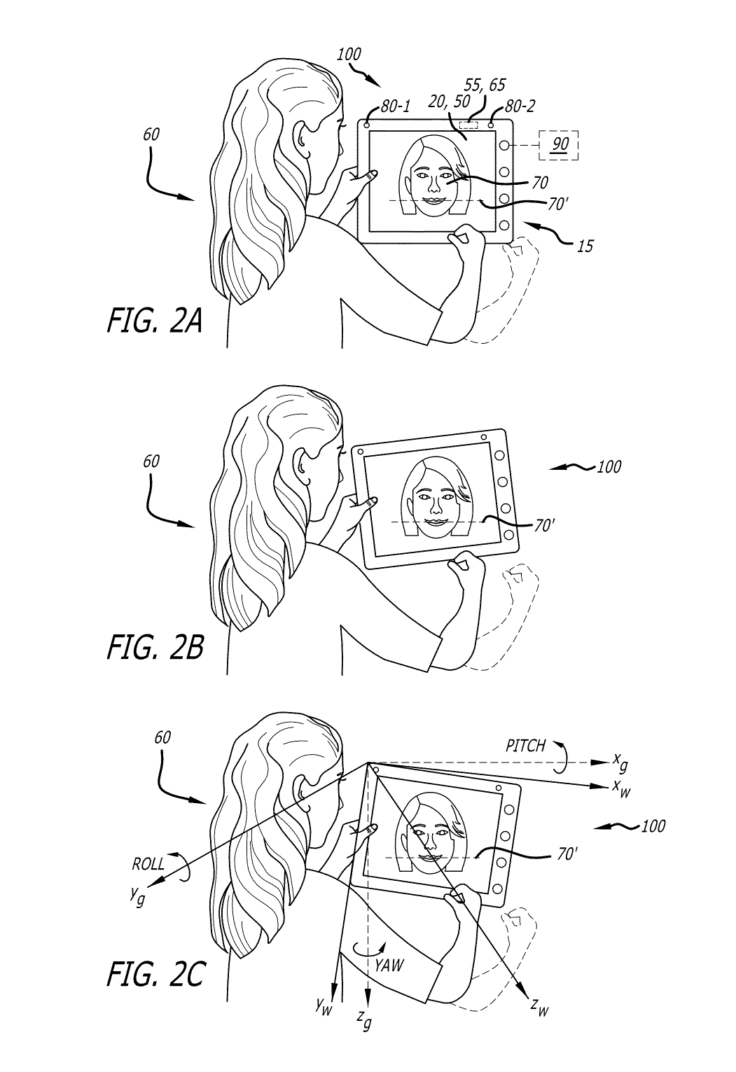

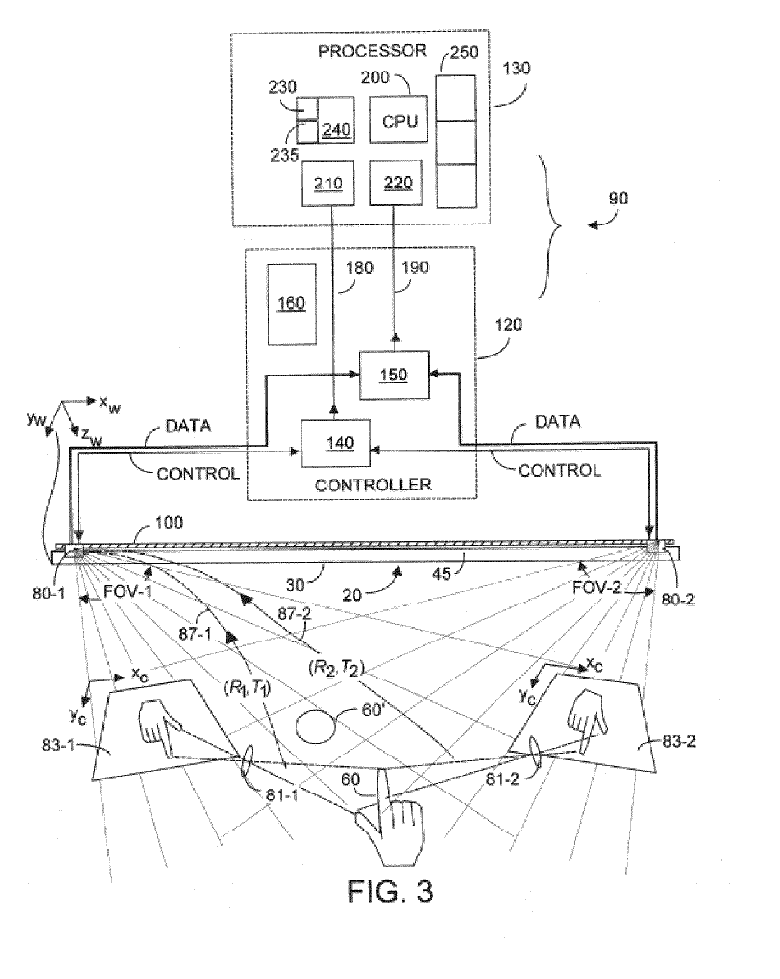

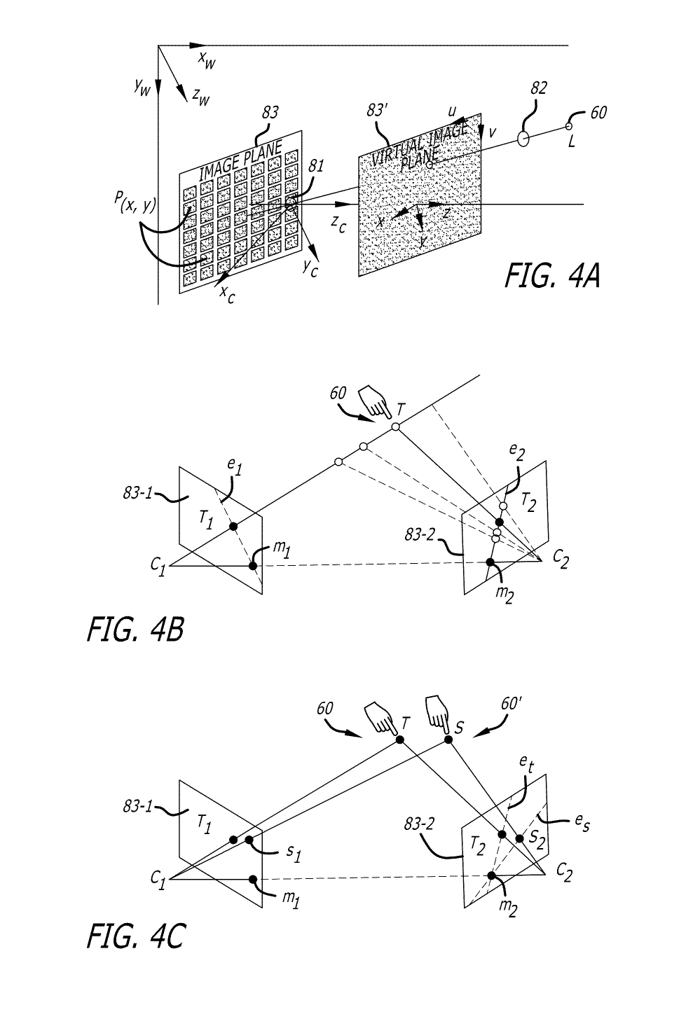

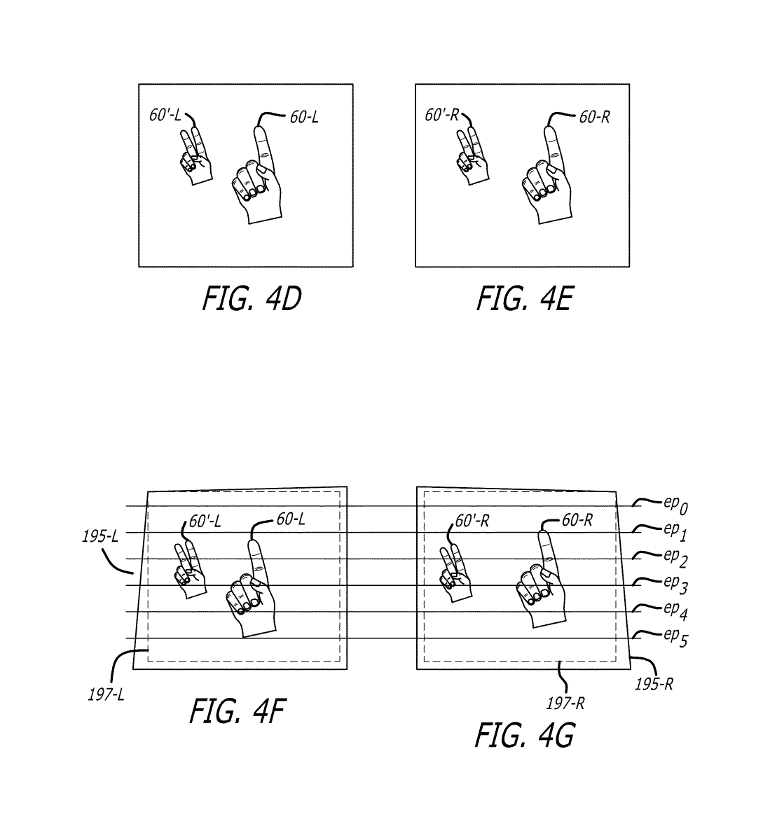

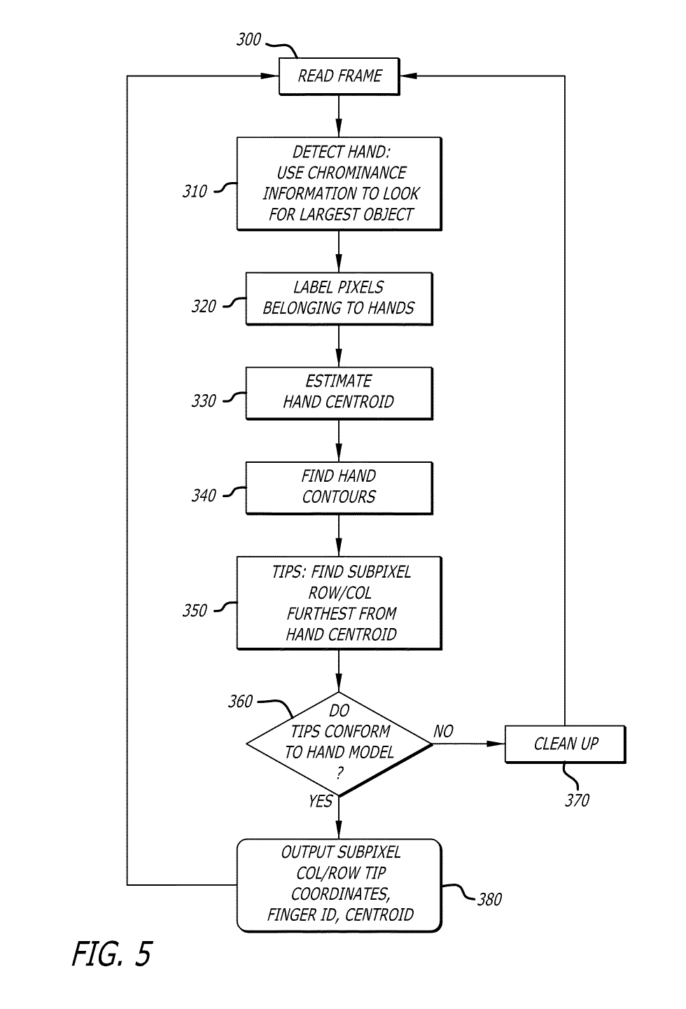

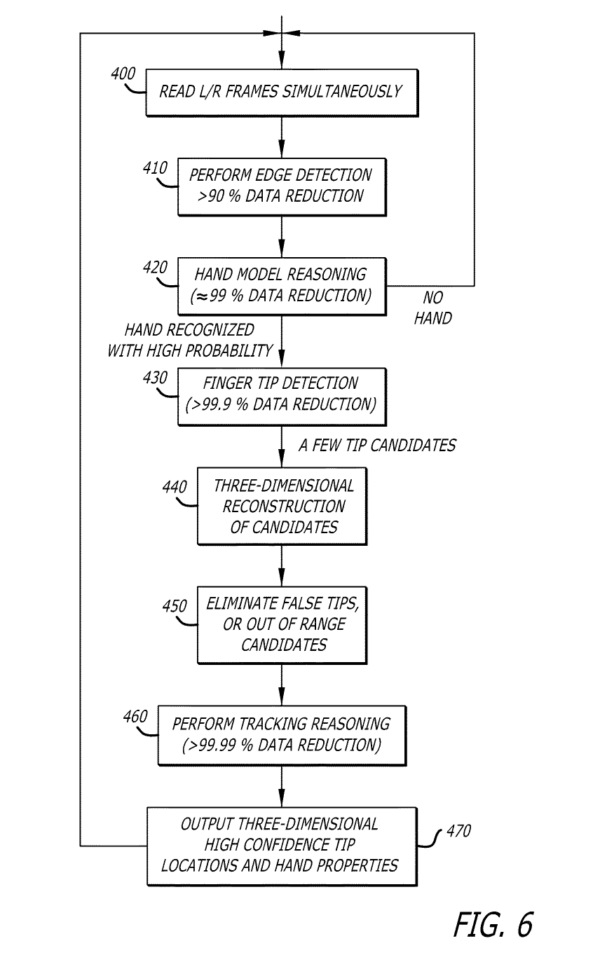

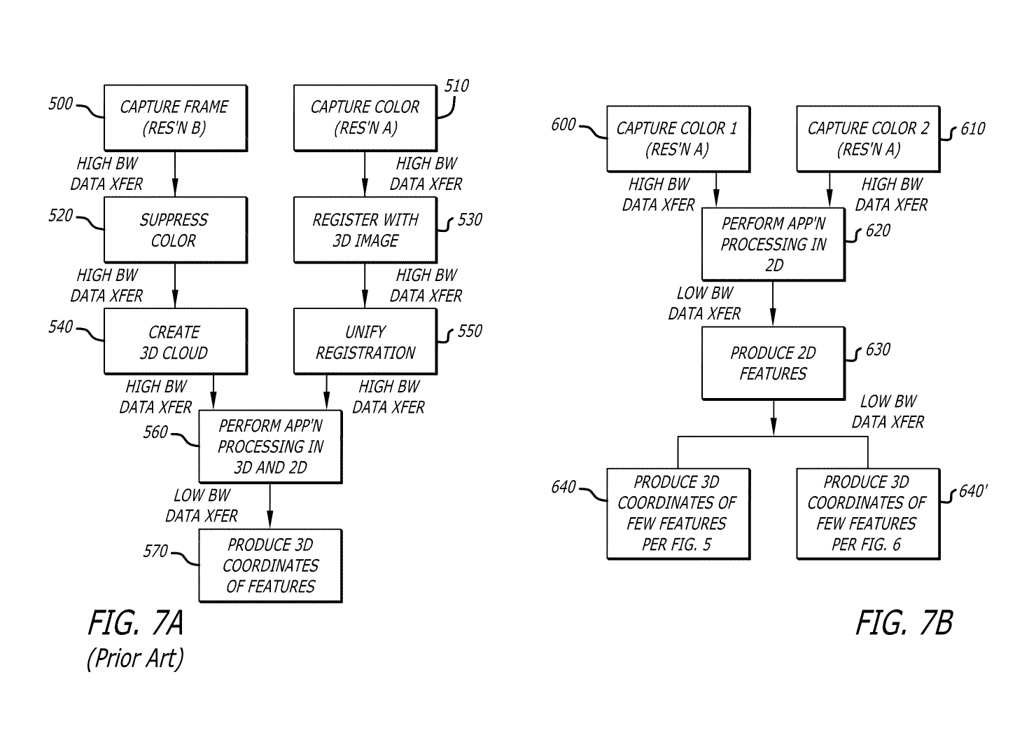

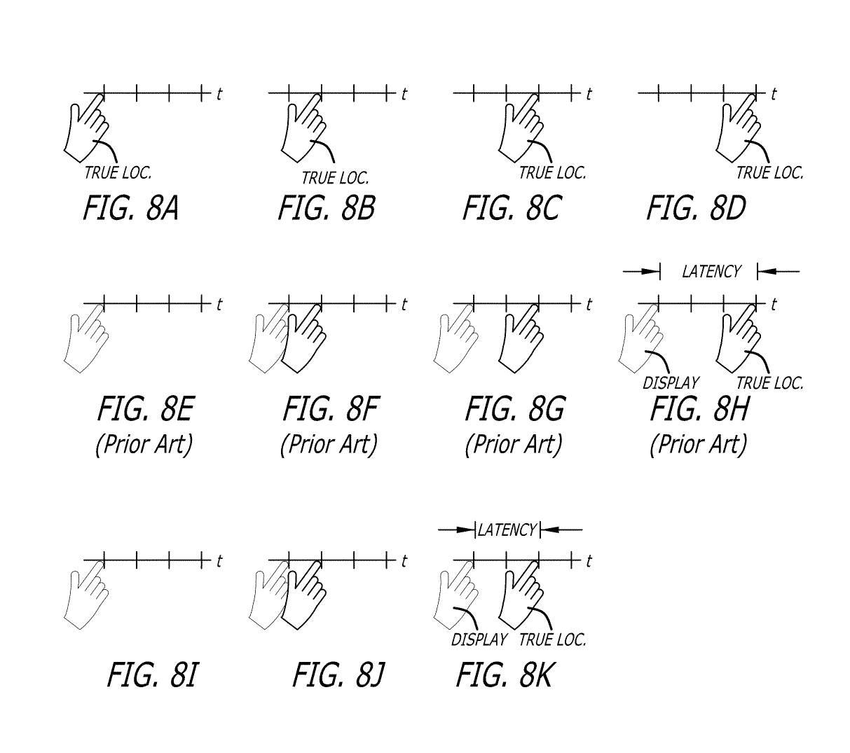

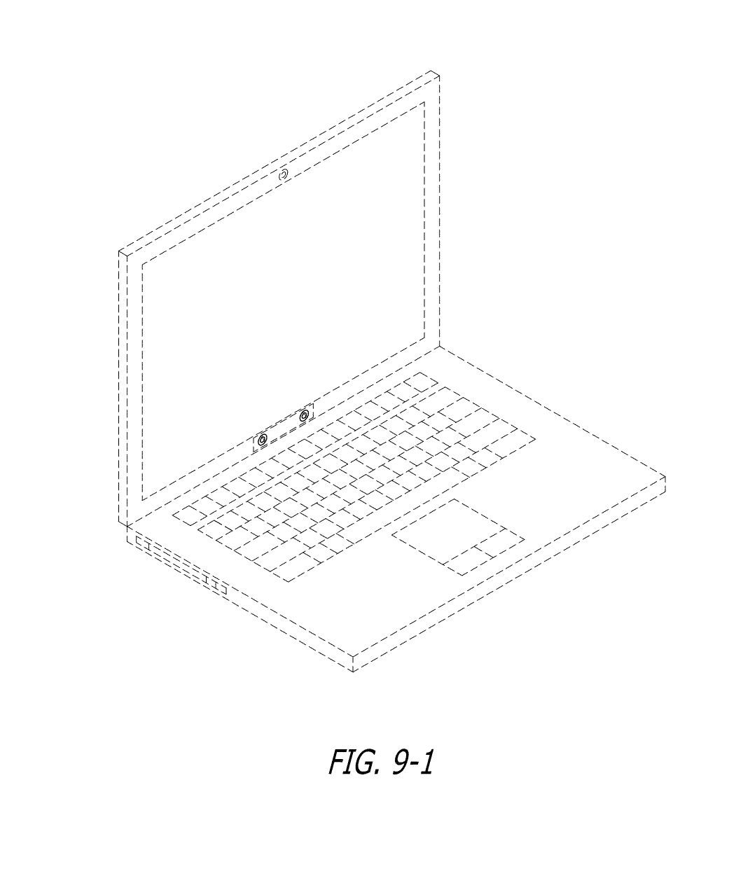

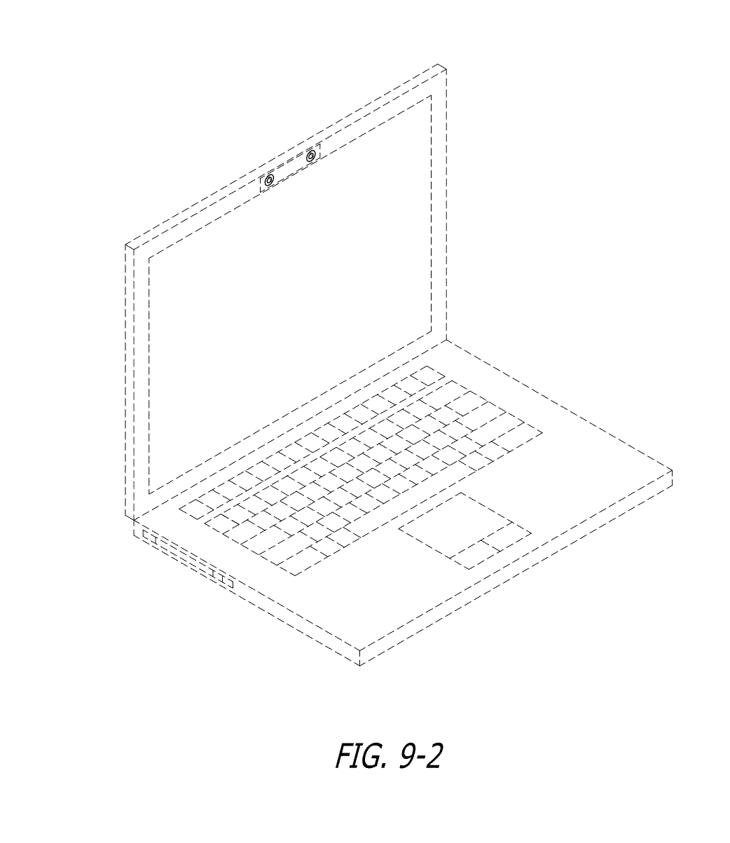

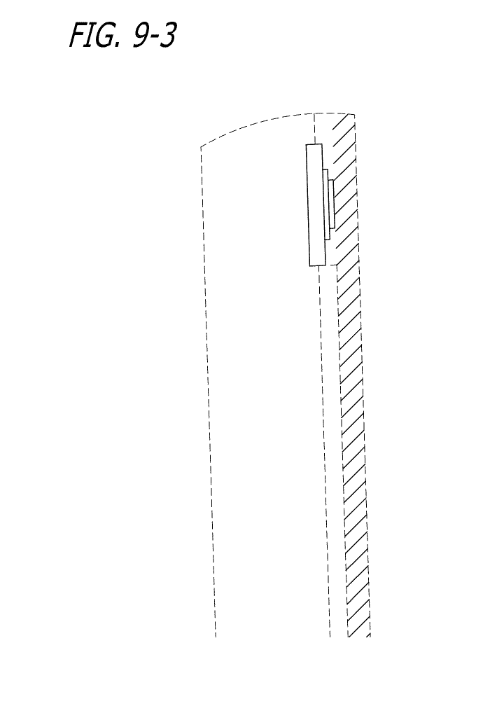

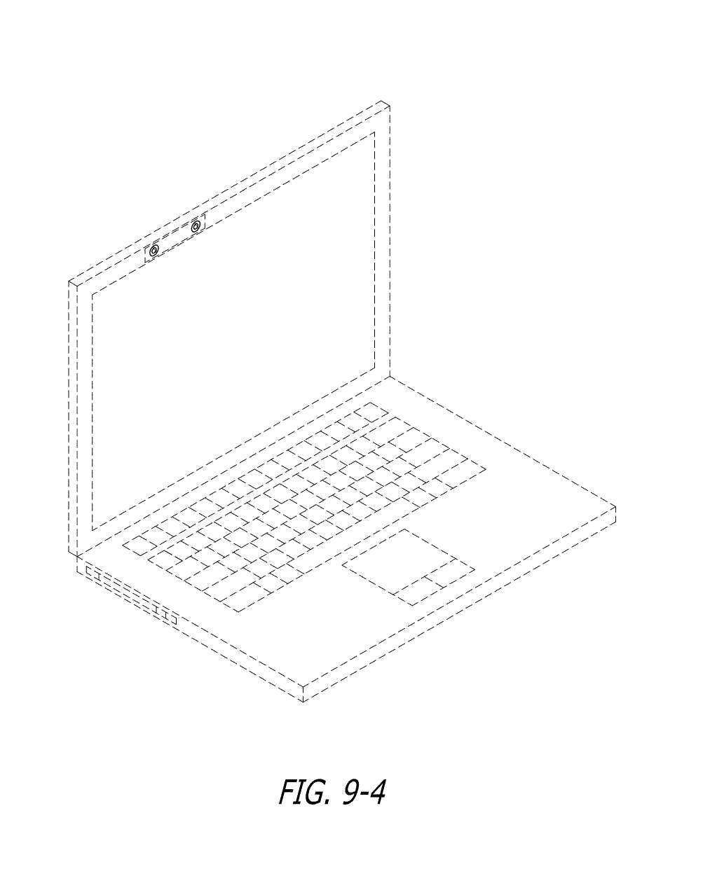

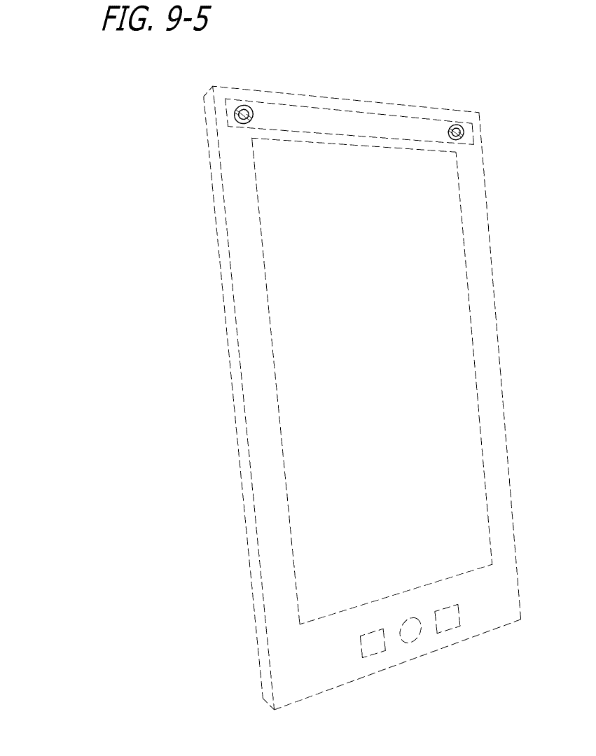

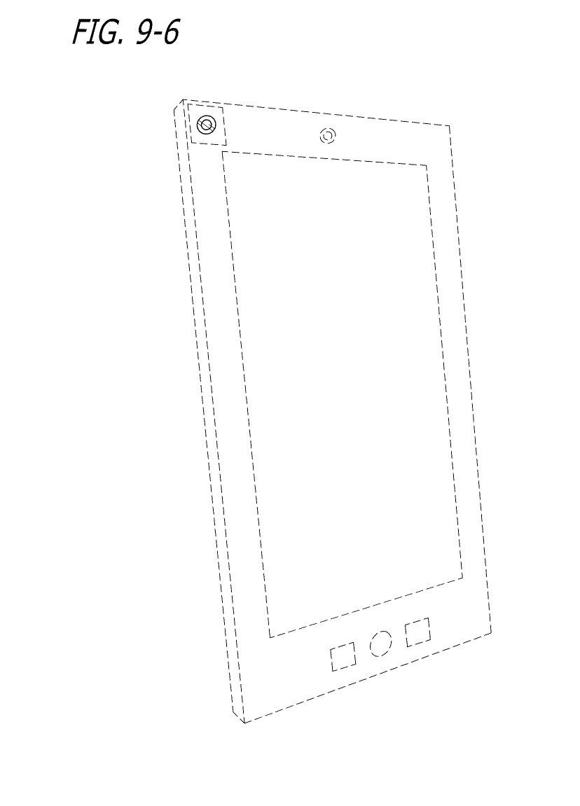

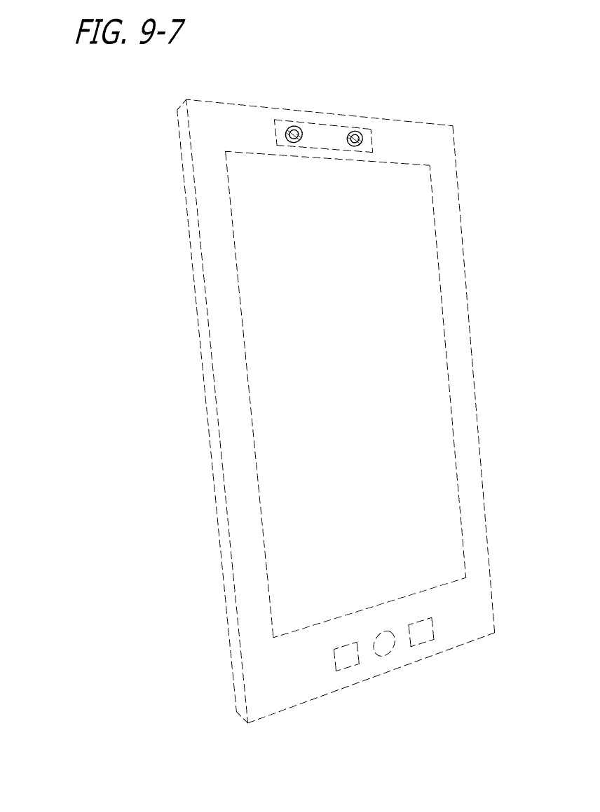

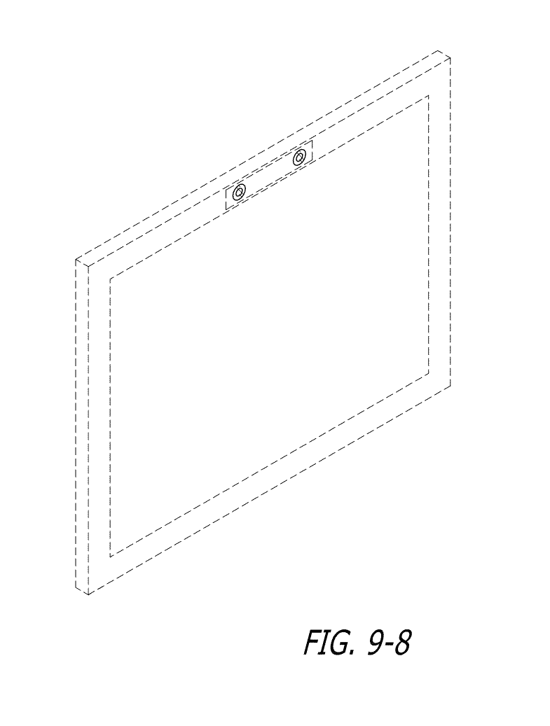

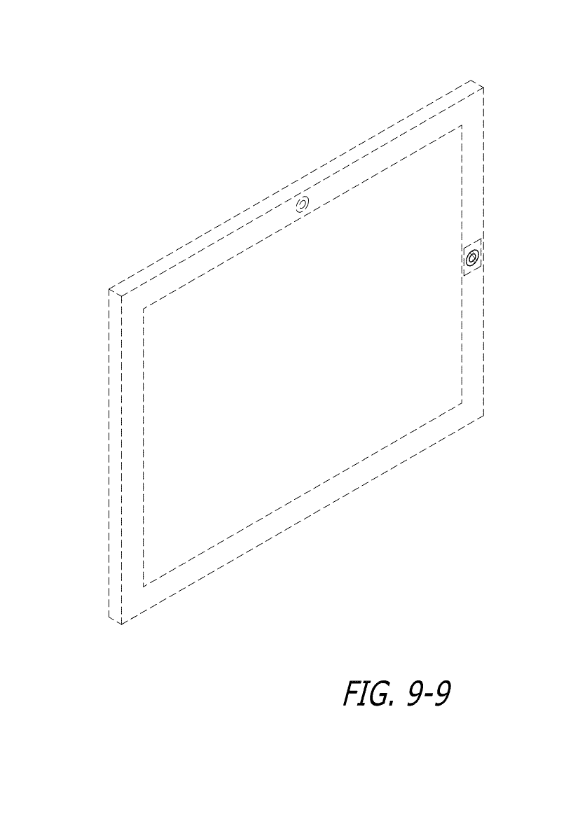

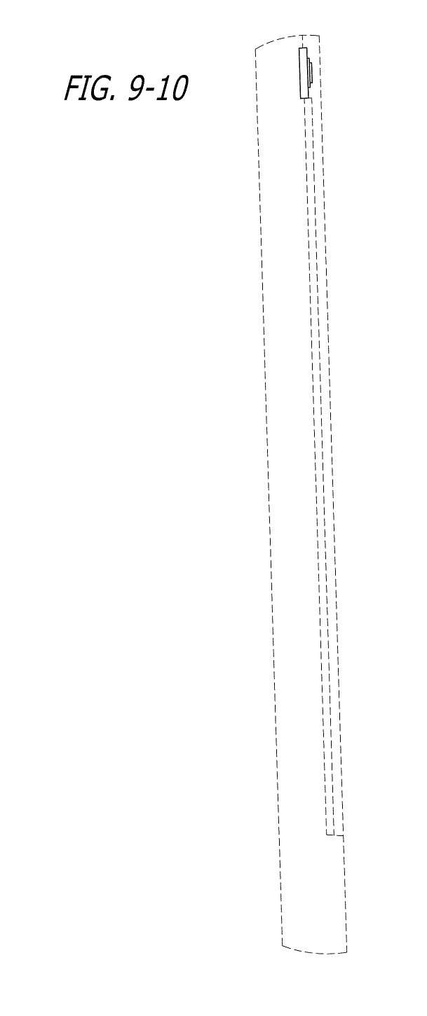

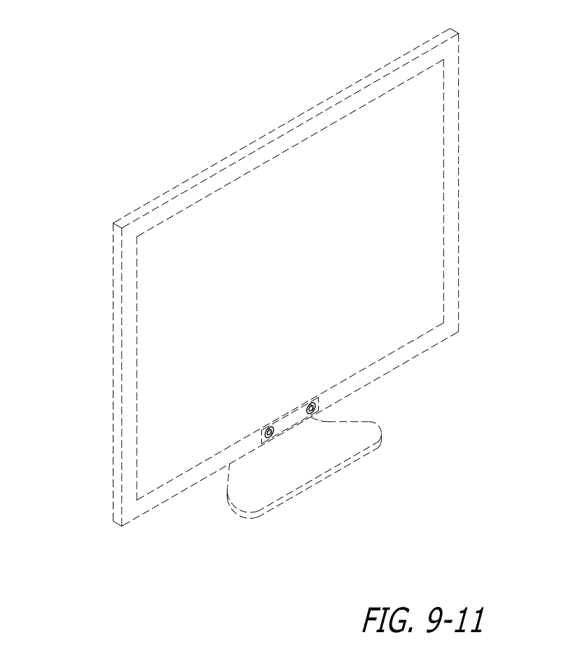

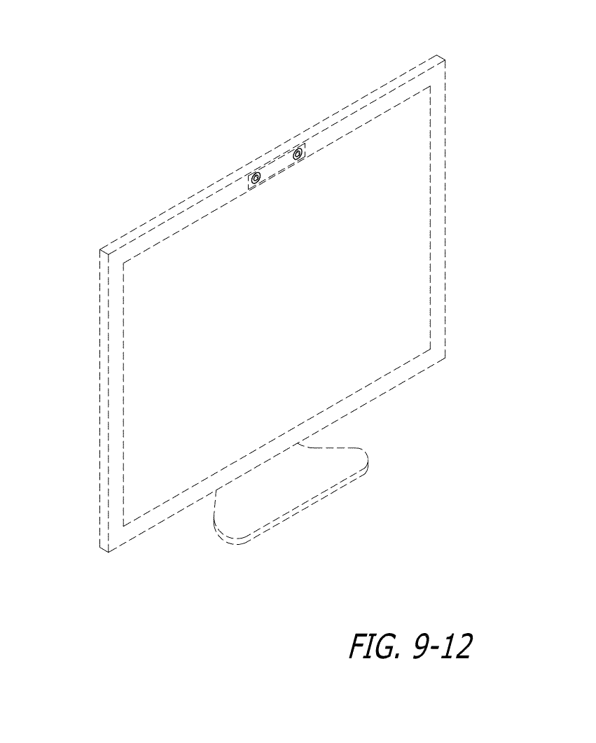

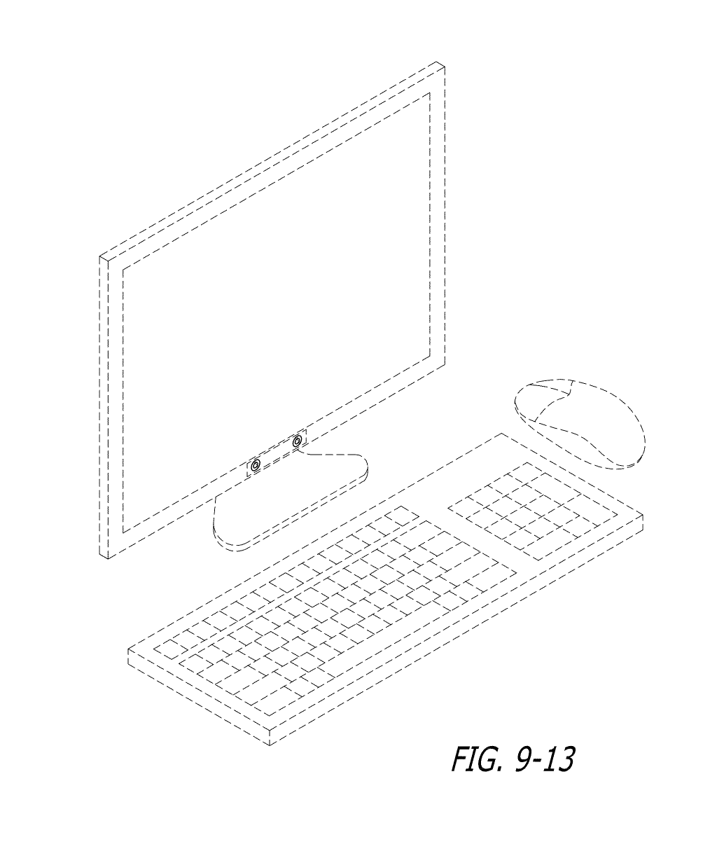

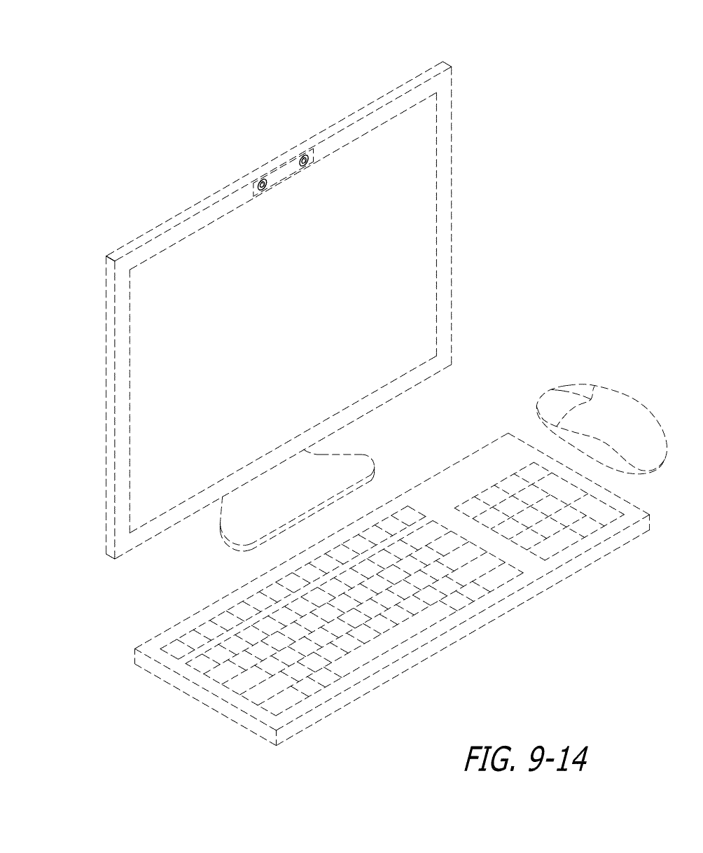

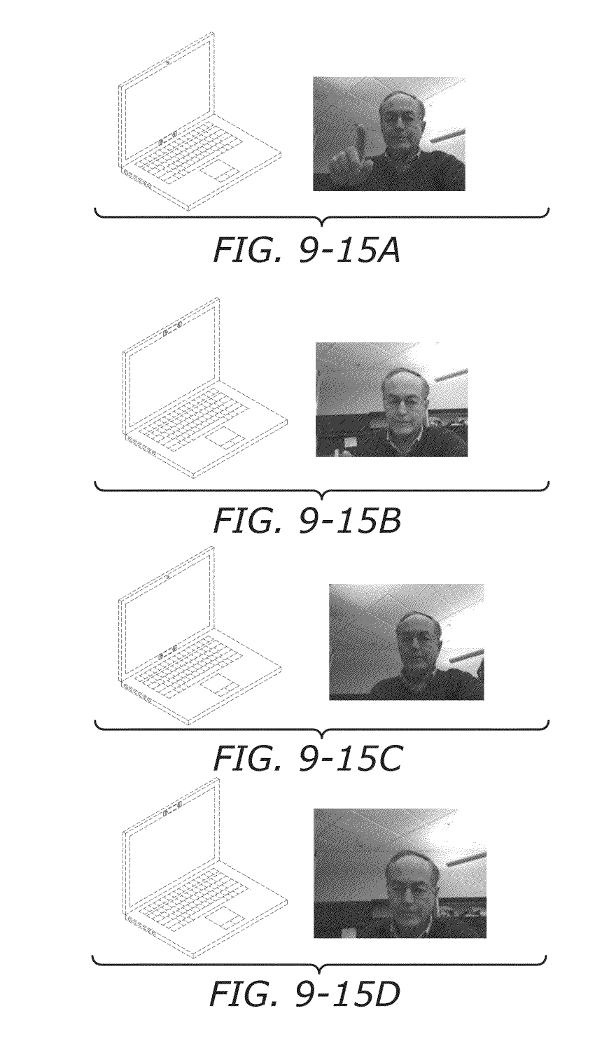

In (a), the user performs a hand gesture by presumably pointing at the screen at the comfortable distance of about 60-70 cm. Note that the entire user head and entire hand is visible. The hand visibility is important for the ability of the detector software using the images produced by the camera to correctly interpret hand position as a user gestures versus other non intentional gestures.

In (b), the user performs substantially the same gesture at the same distance with the same camera as in (a). However, the cameras are installed at the top bezel. Note that the user hand is clipped. To perform the gestures, the user must rotate up his hand and arm into the camera field of view which causes fatigue (also called Gorilla arm syndrome).

In (c), the user is placed in substantially the same position as in (a). The camera is mounted at the bottom bezel. The user face and torso is ideally imaged for applications such as video conferencing. The camera is looking slightly upward and thus less of distracting background scene is not shown.

In (d), the user pose is substantially the same as in (c). The cameras are placed at the top bezel. The camera images less of the user and more of the background scene that may not be desirable for an application such as teleconferencing.

1. A computing device, comprising:
a display system contained within a housing and configured to display images on a display surface; and
a multiview imaging system comprising at least two cameras contained within the housing positioned beneath the display surface and evenly distributed about the centerline of the display surface;
wherein the cameras in the multiview imaging system are synchronized to commence capture of image data within a predetermined time period; and
wherein the cameras in the multiview imaging system have at least partially overlapping fields of view and are configured to capture image data in a 3D hover zone in front of the display surface.
